(19) United States
(12) Patent Application Publication
(10) Pub. No.: US 2024/0391120 A1
(43) Pub. Date: Nov. 28, 2024

(54) SLEEVE FOR HAND TRIMMER

(71) Applicant: Pangaea Holdings, Inc., Los Angeles, CA (US)

(72) Inventor: Ingrid Jackel, Pasadena, CA (US)

(21) Appl. No.: 18/674,228

(22) Filed: May 24, 2024

Related U.S. Application Data
(60) Provisional application No. 63/469,028, filed on May 25, 2023.

(51) Int. Cl. B26B 19/38

(52) U.S. Cl. CPC B26B 19/3806

(57) ABSTRACT

A sleeve for mounting on a battery powered trimmer device that has a water impermeable outer surface, a connector for attaching a handle loop and a port to enable charging of the trimmer with the a cable or by mounting in a charging unit. The sleeve can include a surface region corresponding to the operating switch for the trimmer, one or more light emitters in the trimmer that emit light that is seen with the sleeve on the handle, and one or more graphics windows on the outer surface on which images, symbols and/or lettering can be printed.

### RELATED APPLICATION

This application claims priority to U.S. Provisional Patent Application No. 63/469,028 filed May 25, 2023, the entire contents thereof being incorporated herein by reference.

### BACKGROUND OF THE INVENTION

Electric shavers are used for personal grooming and typically a hard plastic enclosure in which an electric motor, a battery and an operating circuit serve to actuate a vibrating metal teeth that move relative to a stationary blade. The handle typically includes a manually actuated switch to turn the shaver on and off. The battery is rechargeable and there is a connector on an exterior surface of the handle to connect to a power source for recharging. The handle surface is typically a molded plastic material with a uniform color and a smooth surface to be grasped by the hand of the user for cordless trimming of hair.

### SUMMARY OF THE INVENTION

With the development of waterproof handheld trimmers, users are trimming while in the shower, for example. In preferred embodiments, an outer sleeve for the trimmer handle can be used to provide an easy-to-grip outer surface for the handle. The outer surface can comprise a liquid impermeable layer. The waterproof sleeve serves cover and protect the trimmer as described herein. The handle sleeve can be used to cover the trimmer handle and can comprise a textured surface such as a high-quality silicone with embossed designs that allow for optimal grip of the trimmer. The trimmer sleeve can comprise a molded silicone material that is flexible and compressible to be impact resistant.

The handle sleeve can comprise a flexible handle band that conveniently loops onto objects so that the trimmer can hang in the shower, for example. This loop can be attached to the end of the sleeve at the proximal end of the trimmer. The handle sleeve wraps around the user's hand for slip-resistant use, prevents trimmer from falling out of hand, particularly when trimming hard to reach areas.

The handle sleeve allows for easy customization of a trimmer. The appearance of the trimmer can be changed by changing out the sleeve. The user can consequently build and personalize the look of the trimmer with a handle sleeve. The recyclable silicone sleeve provides added protection to a trimmer during use, when stored, and when traveling.

The trimmer can be charged with the sleeve on the trimmer handle. The cable from a battery charger can be connected to the trimmer using an opening at the base of the sleeve. The trimmer and the sleeve can also be inserted into a docking unit that can be used to hold the trimmer when not in use and can also be used the charge the trimmer battery by wireless coupling through the sleeve of by metal prongs that inert into the trimmer handle through openings in the sleeve.

The sleeve can have a graphic region or regions on the exterior surface that can include different graphic elements on different sleeves that can be attached to the trimmer handle. The sleeve can comprise a flexible material that conforms to the shape of the trimmer handle, or can comprise a more rigid molded handle element or elements that snap onto the trimmer handle frame.

### BRIEF DESCRIPTION OF THE DRAWINGS

FIG. 1 is a front view of a handle sleeve for a hair trimmer, according to some embodiments.

FIG. 2 is a side view of the handle sleeve of FIG. 1.

FIG. 3 is a back view of the handle sleeve of FIG. 1.

FIG. 4 is a top view of the handle sleeve of FIG. 1.

FIG. 5 is a bottom view of the handle sleeve of FIG. 1.

FIG. 6 is a front view of a handle sleeve for a hair trimmer, according to some embodiments.

FIG. 7 is a side view of the handle sleeve of FIG. 6.

FIG. 8 is a back view of the handle sleeve of FIG. 6.

FIG. 9 is a top view of the handle sleeve of FIG. 6.

FIG. 10 is a bottom view of the handle sleeve of FIG. 6.

FIG. 11 is a front view of a handle sleeve for a hair trimmer, according to some embodiments.

FIG. 12 is a side view of the handle sleeve of FIG. 12.

FIG. 13 is a back view of the handle sleeve of FIG. 13.

FIG. 14 is a front view of a handle sleeve for a hair trimmer, according to some embodiments.

FIG. 15 is a side view of the handle sleeve of FIG. 14.

FIG. 16 is a back view of the handle sleeve of FIG. 14.

FIG. 17A is a front view of a handle sleeve including a stylized design, according to some embodiments.

FIG. 17B is a back view of the handle sleeve of FIG. 17A.

FIG. 18A is a front view of a handle sleeve including a stylized design, according to some embodiments.

FIG. 18B is a back view of the handle sleeve of FIG. 18A.

FIG. 19 is a sectional view of a trimmer, according to some embodiments.

FIGS. 20A and 20B are front and back views of a further embodiment with front and rear graphical designs with wording included therein

FIGS. 21 and 22 illustrate front and back views with graphical windows defining regions for printing selected images, symbols or words personalized for the user.

### DETAILED DESCRIPTION OF THE INVENTION

Reference will now be made in detail to various embodiments of the disclosed devices and methods, examples of which are illustrated in the accompanying drawings. Wherever possible, the same reference numbers will be used throughout the drawings to refer to the same or like parts.

As used in the specification and claims, the singular form “a,” “an,” and “the” include plural references unless the context clearly dictates otherwise.

One of the challenges with existing hair trimmer solutions is the grip of the trimmer. Prior solutions focused on the ergonomics of the trimmer. However, this approach has limited effectiveness and does not allow for simple customization of the trimmer.

The present disclosure provides sleeve for a conventional hair trimmer with improved gripping ability for a user. In some embodiments, the sleeve is waterproof. In some embodiments, the sleeve is customizable, featuring graphic designs or color schemes selected by the user.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Like numerical identifiers are used throughout the figures to refer to the same elements.

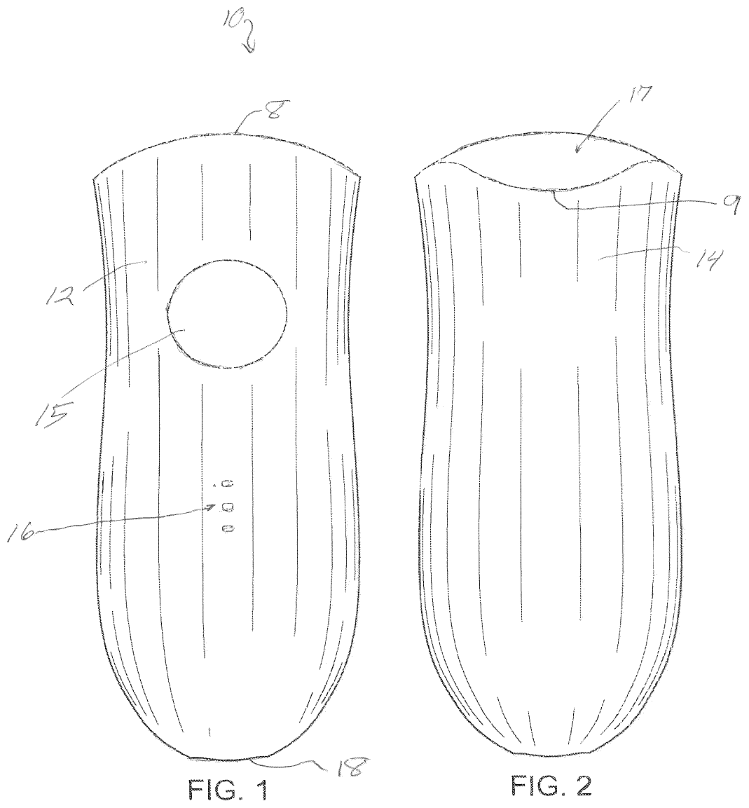

FIGS. 1-10 depict exemplary designs for a handle sleeve for a hair trimmer. Note generally that the sleeve for a trimmer handle as described herein has a thickness in a range of 1-3 mm, and preferably of about 2 mm, in the various embodiments described herein. The sleeve body can comprise a compressible material such as silicone that compresses upon gripping or impact and can thus be used to prevent damage to the trimmer in the event it is accidentally dropped, for example. The outer surface can comprise a solidified oil layer that can be printed with ornamental features as described herein. The width of the sleeve can vary between 40-50 mm, for example, and preferably has a maximum compressed width of about 45 mm. Sleeve 10 as seen in the front and back views of FIGS. 1 and 2, have an upper edge 8 defining a top to bottom length in a range of 100-125 mm. and preferably of about 112 mm. The base 18 of the sleeve can comprise the connector that connects to a flexible band or loop as described herein. The front side 12 can include a raised or border region 15 where the user can press the activating switch on the trimmer handle by pressing the region 15 wherein the region aligns with the underlying switch when mounted to the trimmer by sliding the open top at 17 onto the bottom of the trimmer handle assembly. The top 9 of the backside 14 is lower than the top 8 of the frontside, or vice versa. Thus, the length of the frontside 12 is different than the length of the backside 14.

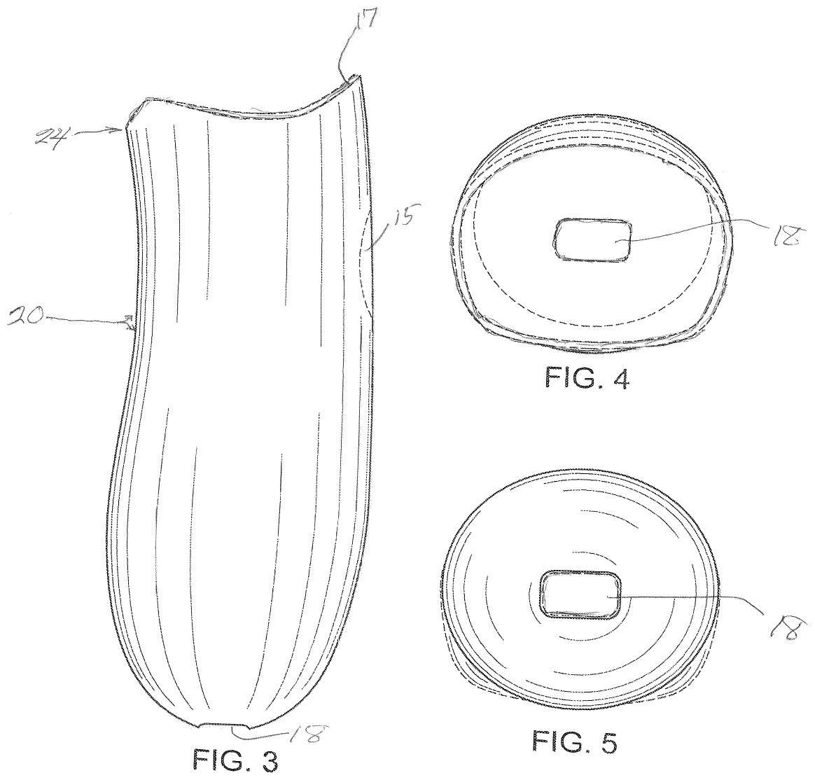

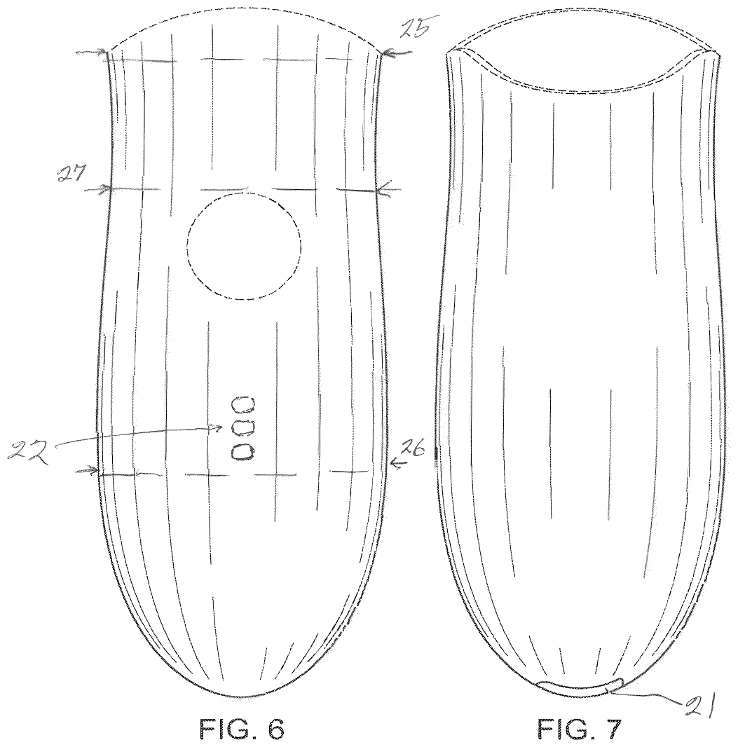

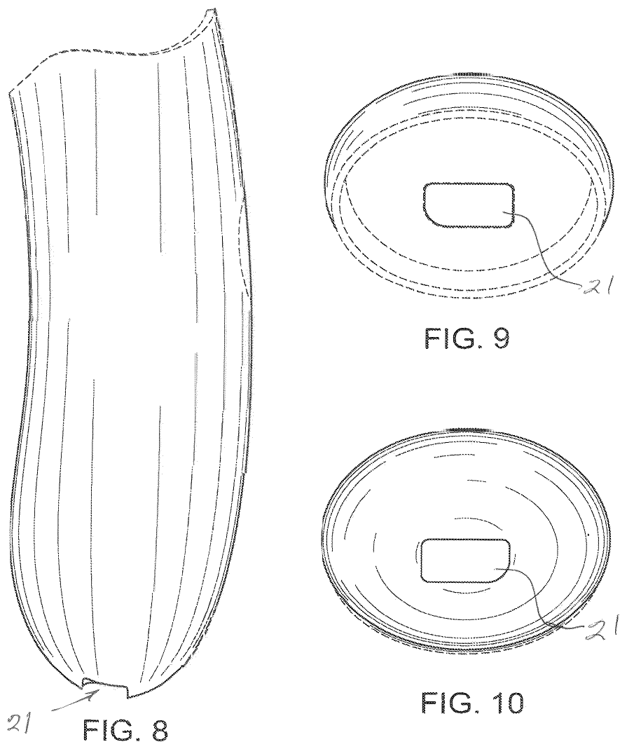

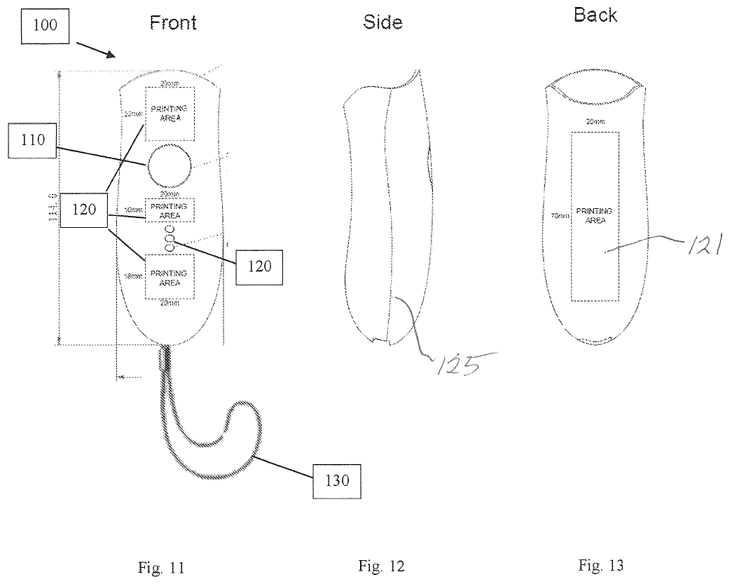

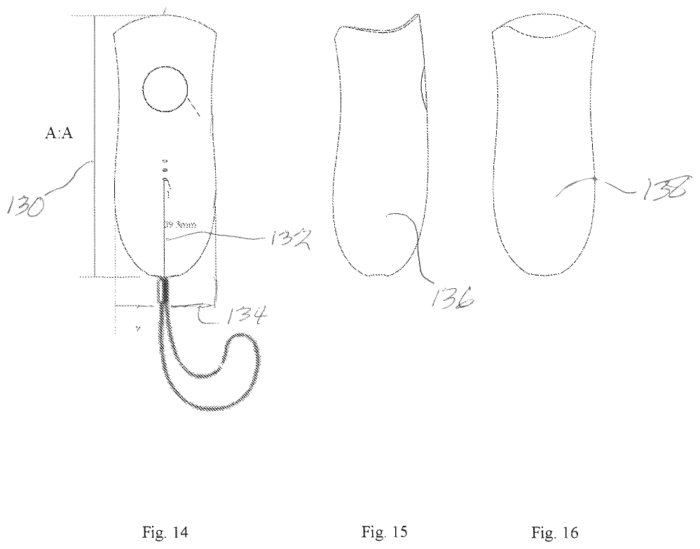

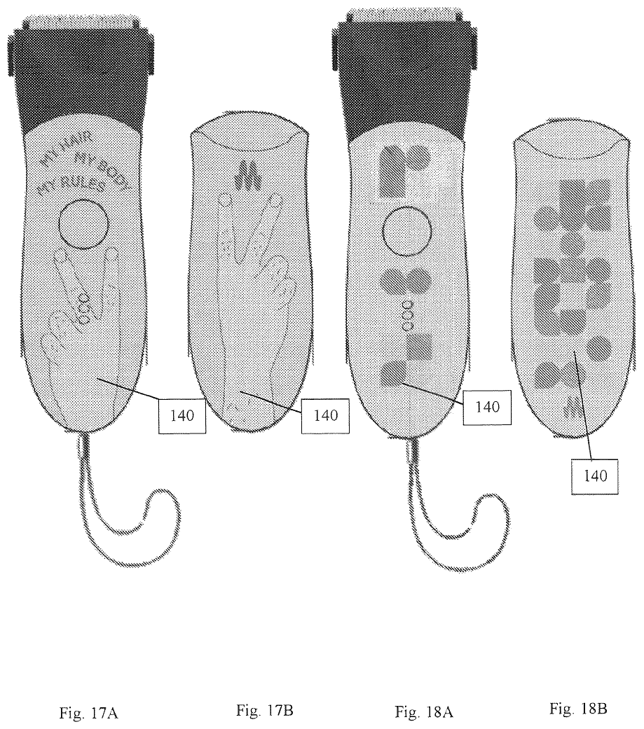

FIG. 3 shows a sidewall of the sleeve with the top frontside 17 positioned over the region 15 and showing the curved contour of the frontside and the backside where a recess 20 shows a minimum width between the front and the back of the sleeve. The top back edge at 24 shows a maximum width extending above the minimum recess 20. The top view of the sleeve in FIG. 4 shows an opening 18 and connector region at the base of the sleeve that is also seen in the bottom view of FIG. 5. FIG. 6 shows a maximum upper width at 25 near the top of the sleeve, a minimum width at 27 near or at the switch region, and a maximum lower width at 26 near or at the LED emitter region 22. The connector region 21 and/or charging cable opening 21 is shown in FIG. 7, the sidewall view of FIG. 8, the sleeve top view of FIG. 9 and the bottom view of FIG. 10.

FIG. 11 is a front view of an exemplary handle sleeve 100 for a hair trimmer. FIG. 12 is a side view thereof that shows a centerline or seam 125 for the sleeve. FIG. 13 is a back view thereof. Sleeve 100 may be composed of a waterproof material. In some embodiments, the waterproof material is silicone. Waterproof material may be desirable in situations where a user employs a hair trimmer in a shower or bath, for example. In some embodiments, the sleeve 100 may be composed of recyclable material. In some embodiments, the sleeve 100 may be composed of a material that provides added protection to a trimmer during use, and when stored, for example for travel. The sleeve 100 may comprise a flexible material that conforms to the shape of the trimmer, or alternatively may comprise a more rigid molded handle element or elements that snap onto the trimmer frame.

In some embodiments, sleeve 100 covers substantially all of the body of a hair trimmer. For example, the sleeve 100 may leave the blades of the trimmer exposed. In other embodiments, the sleeve 100 covers a portion of the hair trimmer. For example, multiple sleeves 100 may be attached to a trimmer and may abut one another to cover the trimmer.

In some embodiments, the sleeve may also range from 30-50 mm in width. In further embodiments, the sleeve may also range from 40-45 mm in width. In some embodiments, the sleeve may also range from 100-120 mm in length. In further embodiments, the sleeve may also range from 108-114 mm in length.

In some embodiments, the sleeve 100 has a recess 110 for exposing a power button of the trimmer. In some embodiments, the sleeve include smaller holes 112 for exposing light emitting features on a trimmer.

In some embodiments, the sleeve 100 is composed of material that may be easily gripped by a user. For example, the sleeve 100 includes a textured surface to improve the grip of the sleeve 100. In some embodiments, the textured surface may include embossed features or graphics window(s) 120. The embossed features 120 may be selected by a user to exhibit a customized design. In other embodiments, the embossed features are designed solely to improve the grip of the sleeve 100. The rear side can have printing area 121 in which images, symbols or lettering can be printed as seen in FIG. 13. The length 130, width 134 and the distance from the base to the LEDs 132 are shown in FIG. 14, with the sidewall 136 and backside shown in FIGS. 15 and 16. Generally, FIGS. 11-16 depict an embodiment of a sleeve designs 100 that does not include embossed or printed features.

The sleeve 100 may include a loop 130 that loops onto the trimmer, allowing the trimmer to hang in the shower. For example, the loop 130 may be positioned such that the trimmer may be hung on a feature, such as a hook or shower head or basket. In some embodiments, the loop 130 may be configured to wraps around a user's hand to prevent the user from dropping the trimmer, or to prevent the trimmer from slipping out of the user's hand. The loop 130 is particularly useful when a user is employing the trimmer in harder to reach to reach areas, such as the back or legs.

In some embodiments, the loop 130 can be attached to an end of the sleeve 100, for example at the proximal end of the trimmer. In other embodiments, the sleeve 130 may include an aperture at the proximal end that allows passage of a loop feature attached to a trimmer.

The handle sleeve 100 allows for easy customization of a trimmer. For example, the appearance of the trimmer can be changed by changing out the sleeve 100. As can be seen in FIGS. 17A-18B, each sleeve 100 may feature a different graphical design. The user can consequently build and personalize the look of the trimmer with a handle sleeve 100.

The sleeve 100 can have a graphic region or regions 140 on the exterior surface that can include one or more graphic elements. A user may be able to swap one sleeve 100 for another to change the appearance of the trimmer. In some embodiments, multiple sleeves 100, each with differing graphic elements, may be attached to a trimmer.

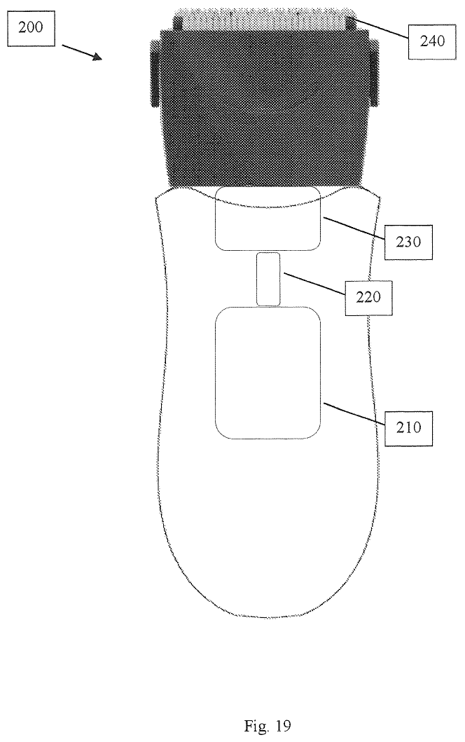

FIG. 19 depicts a sectional view of a hair trimmer 200. The trimmer 200 may include a power source 210, for example a battery. The power source 210 may be electrically connected to a power connector 220. The power connector 220 may be configured to deliver power from the power source 210 to a motor 230. The motor 230 may operate one or more blades 240 of the trimmer 200.

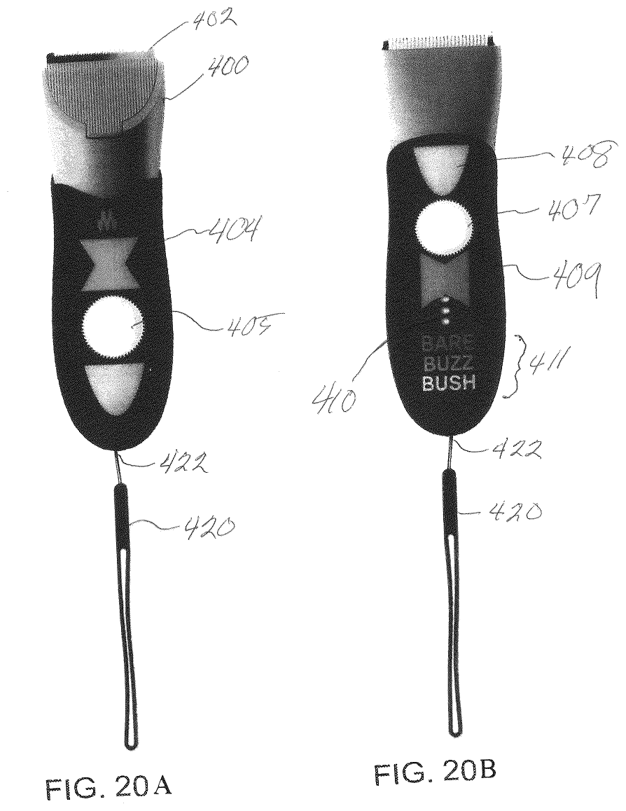

FIGS. 20A and 20 B show back and front sides of a further embodiment of a trimmer 400 and a hair trimmer blade assembly 402 as described previously herein with a sleeve 404 mounted thereon. The sleeve has a light emitting region 410 through which the LEDs on the trimmer handle assembly transmit light during use to identify that power is on or the charged or charging state of the trimmer. Graphic symbols 405, 407, 408 and 409 can be printed on the front and/or back sides of the sleeve. One of the symbols, such as symbol 407, can denote the location of the power activation switch for the trimmer, for example. The words or lettering 411 can be included in the graphics window for this design. A flexible band or loop 420 can be used to manually hold the sleeved trimmer and/or be slung over the user's wrist, or be hung in a shower, bath or other location for convenience. The band 420 can be mounted at connector 422 at the base of the sleeve.

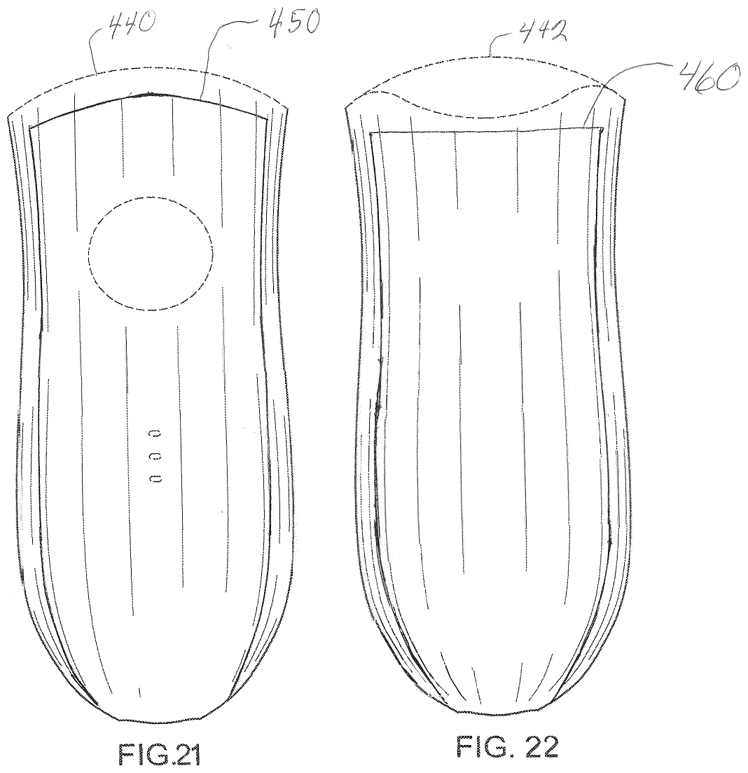

FIGS. 21 and 22 illustrate front and back sides wherein the top 440 of the front or first side of the sleeve lies above an outline of a graphics window 450 on the front of the sleeve in which images, symbols and/or lettering may be printed wherein the window 450 is contoured to the outer shape of the front side of the sleeve. Similarly, the top 442 as seen from the backside of the sleeve extends above a backside graphics window 460 that is contoured to the back or second side of the sleeve. Note that further embodiments of the trimmer sleeves shown and described herein can also include graphics windows on one or both sidewalls or that extend circumferentially around all sides of the one or more sleeves.

Other embodiments will be apparent to those skilled in the art from consideration of the specification and practice of this disclosure. It is intended that the specification and examples be considered as exemplary only, with the true scope and spirit of the disclosed devices and methods being indicated by the following claims.

While various embodiments of the invention have been shown and described herein, it will be obvious to those skilled in the art that such embodiments are provided by way of example only. Numerous variations, changes, and substitutions may occur to those skilled in the art without departing from the invention. It may be understood that various alternatives to the embodiments of the invention described herein may be employed.

We claim:

1. A trimmer handle sleeve comprising:
a hollow sleeve having an open end to receive an electric trimmer, the sleeve comprising a flexible material that conforms to a shape of a handle body of the electric trimmer;
a patterned region on the handle sleeve corresponding to a trimmer switch on the handle body wherein manual actuation of the patterned region actuates the trimmer switch; and
a connector at a closed end of the hollow sleeve.

2. The sleeve of claim 1 further comprising an outer contoured surface of the hollow sleeve to be grasped by a user for operation of the trimmer.

3. The sleeve of claim 1 wherein the hollow sleeve comprises an elastic material that at least partially expands to conform to the handle body during insertion into the hollow sleeve.

4. The sleeve of claim 1 wherein the hollow sleeve comprises a liquid impermeable shell.

5. The sleeve of claim 1 wherein the hollow sleeve comprises a silicone material.

6. The sleeve of claim 1 wherein a flexible band is attachable to the connector.

7. The sleeve of claim 2 further comprising a graphic region on the outer contoured surface.

8. The sleeve of claim 7 wherein the graphic region is on a first side of the hollow sleeve.

9. The sleeve of claim 8 further comprising a second graphic region on a second side of the hollow sleeve.

10. The sleeve of claim 1 wherein the hollow has a thickness between an outer surface an inner surface that comprises a compressible material.

11. The sleeve of claim 1 further comprising a battery charging coupling through a portion of the sleeve.

12. The sleeve of claim 11 wherein the coupling portion can be positioned within a docking unit for battery charging, or an opening in the sleeve for connecting a charging cable to the trimmer handle, or for wireless charging.

13. The sleeve of claim 1 wherein the sleeve has a thickness in a range of 1-3 mm and the outer surface comprises a solidified oil configured for printing of images, symbols and/or lettering.

14. The sleeve of claim 1 wherein the sleeve has a varying width between 40-50 mm and a length between 100-125 mm.

15. The sleeve of claim 1 wherein a trimmer activation region on the sleeve is aligned with a trimmer activation switch on a trimmer handle.
